(19) United States
(12) Patent Application Publication
(10) Pub. No.: US 2026/0347150 A1
(43) Pub. Date: Nov. 5, 2026

(54) Escalator

(71) Applicant: Jang-Moon LEE, Seoul (KR)

(72) Inventor: Jang-Moon LEE, Seoul (KR)

(21) Appl. No.: 19/658,926

(22) Filed: Apr. 27, 2026

(30) Foreign Application Priority Data
May 2, 2025 (KR) 10-2025-0057929

(51) Int. Cl. B66B 23/02; B66B 21/04; B66B 25/00; H02K 7/116; H02K 21/24

(52) U.S. Cl. CPC B66B 23/026; B66B 21/04; B66B 25/00; H02K 7/116; H02K 21/24

(57) ABSTRACT

An escalator for moving passengers automatically between floors is provided. The escalator includes a power generating unit, a carrier for transporting passengers via caterpillar-type steps installed between a pair of left and right driving and driven sprockets mounted to an inclined truss that travel by a driving force, and a transport unit for passenger safety. The power generating unit is an axial flux motor installed on and coaxially with the driving sprockets, and a cycloid transmission installed between the driving sprockets and the axial flux motor to transmit a driving force to the driving sprockets. The driving sprockets rotates at reduced speed allowing the caterpillar-type steps to travel at a constant low speed. Design flexibility within a limited space is enhanced, efficiency loss is reduced, travel of the carrier of the transport unit is stabilized, and repair and maintenance of the facility are facilitated.

### CROSS-REFERENCE TO RELATED APPLICATION

This present application claims priority to Korean Application No. 10-2025-0057929 filed on May 2, 2025, the entire contents of which are hereby expressly incorporated by reference into the present application.

### TECHNICAL FIELD

The present invention relates to an escalator provided as a mobility convenience facility for moving passengers automatically upward and downward between floors by using power.

### BACKGROUND

Various types of escalators, provided to move passengers upward and downward in buildings or underground passages, have been developed and installed to date.

Such escalators are broadly divided into a power generating unit and a transport unit provided inclinedly in upward and downward directions.

To describe this in more detail, the former, the power generating unit, comprises a drive motor operating in response to a signal from an operation control unit, a speed reducer, and a drive chain.

The latter, the transport unit, is operated by an indirect drive method, comprising: a pair of left and right driving sprockets and driven sprockets installed at inclined upper and lower portions, being driven by a reduced driving force transmitted from the drive chain of the power generating unit; caterpillar-type steps of a link chain type installed between the sprockets, which maintain a horizontal state at the upper and lower portions for passenger boarding and alighting and transform into steps in an inclined section; and handrails provided on both sides of the caterpillar-type steps.

In such an indirect drive type escalator, the installation space for the separately provided power generating unit is unnecessarily large, which reduces design flexibility in a limited space.

Furthermore, various problems in maintenance as well as safety accidents are occurring, such as an interruption of operation due to the separation of a power transmission member between the power generating unit and the transport unit, or personal injury caused by a reverse travel of the transport unit when the power transmission member is fractured due to excessive load or wear.

Accordingly, direct drive type escalators are being developed to solve the problems found in the indirect drive type escalators.

Thus, escalators employing a mechanical direct power transmission method are being developed to address the issues associated with the indirect power transmission type escalators.

Such direct power transmission type escalators are provided with a reduction unit that transmits a driving force from a drive motor to a driving sprocket of a transport unit via a driving gear, at least one or more multi-stage driven gears installed in succession, and an output gear between a power generating unit and the transport unit.

However, such direct power transmission type escalators using a reduction unit involve problems such as friction and noise caused by the meshing of multi-stage gears, damage to components and a decrease in power transmission efficiency due to vibration, and unsuitability for high torque transmission.

In addition, the design and manufacture of the reduction unit are complicated, making the repair and replacement of components difficult; furthermore, the continuous lubrication management of the multi-stage gears is required, and the difficulty in repair and replacement of components causes many problems in the maintenance of the mobility convenience facility.

Furthermore, the driving and driven sprockets of the transport unit suffer from damage or fracture problems due to wear caused by friction occurring during operation, which essentially requires maintenance such as periodic and regular repair and replacement; however, there is a problem in that the work of separating and disassembling the driving and driven sprockets from the shafts is not easy.

To explain further, a sprocket formed as a single body is installed in a cross direction on a shaft horizontally installed between a pair of left and right bearing blocks; as such, in order to separate the sprocket installed on the shaft, the relatively heavy shaft must first be separated from the bearing blocks, making the repair and replacement of the sprocket difficult and resulting in many problems such as poor maintainability of the transport unit.

### SUMMARY OF INVENTION

### Technical Subject

The present invention aims to provide an escalator configured to enhance design flexibility within a limited space by coaxially providing a power generating unit, which is an axial flux motor, and cycloid transmissions on a driving side of a carrier, to reduce efficiency loss by shortening a power transmission path through direct power transmission, and to reduce driving noise and vibration as well as to simplify the structural configuration of the facility.

Another object of the present invention is to provide an escalator that ensures stable operation of a transport unit by driving a carrier via a direct drive method, has a relatively simple structure, facilitates maintenance and repair of the facility, and prevents safety accidents involving reverse travel due to fracture.

Still another object of the present invention is to provide an escalator that facilitates repair and maintenance of the facility by providing driving and driven sprockets divided into halves to simplify replacement work caused by wear or damage.

### Solution to Problem

The present invention aims to provide a direct drive type escalator capable of solving the problems of design flexibility in a limited space, operation interruption due to fracture of a power transmission system, and safety accidents, which occur in an indirect power transmission type escalator provided in a step-like shape as a mobility convenience facility for automatically moving passengers upward and downward between floors by using power.

The present invention relates to an escalator comprising: a power generating unit that operates in response to a signal from an operation control unit; a carrier for transporting passengers upward and downward via caterpillar-type steps that are installed between a pair of left and right driving and driven sprockets mounted at top and bottom portions of an inclined truss and travel by a driving force transmitted from an output shaft of the power generating unit; and a transport unit including the carrier and handrails provided on both sides thereof for passenger safety; wherein the power generating unit is an axial flux motor installed on and coaxially with each of the pair of driving sprockets, and a cycloid transmission is installed coaxially between the driving sprockets and the axial flux motor to transmit a driving force from the axial flux motor to the driving sprockets such that the driving sprockets rotates at reduced speed, thereby allowing the caterpillar-type steps to travel at a constant low speed; whereby design flexibility within a limited space is enhanced, efficiency loss is reduced by shortening a power transmission path through direct power transmission, travel of the carrier of the transport unit is stabilized, and repair and maintenance of the facility are facilitated.

These and other features and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### Advantageous Effects of Invention

According to the escalator of the present invention, by installing a power generating unit, which is an axial flux motor, and cycloid transmissions coaxially on rotating shafts of driving and driven sprockets of a carrier in a transport unit, design flexibility within a limited space for the facility is enhanced, and the carrier is driven by a direct drive method, thereby reducing efficiency loss due to a shortened transmission path and achieving stable travel of the carrier.

In addition, the present invention has an effect of facilitating repair and maintenance of the facility by bisecting the driving and driven sprockets of the carrier to allow easy replacement work caused by wear or damage.

### BRIEF DESCRIPTION OF DRAWINGS

Preferred exemplary embodiments of the invention are illustrated in the accompanying drawings in which like reference numerals represent like parts throughout, and in which:

FIG. 1 is a longitudinal sectional view schematically showing the overall configuration of an escalator according to the present invention.

FIG. 2 is an enlarged sectional view taken along line A-A of FIG. 1.

FIG. 3 is a partially exploded perspective view showing an excerpt of a driving unit applied to the escalator of the present invention.

FIG. 4 is an enlarged sectional view taken along line B-B of FIG. 2.

FIG. 5 is an enlarged sectional view taken along line C-C of FIG. 2.

FIG. 6 is an explanatory view showing another embodiment of driving and driven sprockets provided in driving and driven units of the escalator according to the present invention.

In describing the preferred embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the word connected, attached, or terms similar thereto are often used. They are not limited to direct connection but include connection through other elements where such connection is recognized as being equivalent by those skilled in the art.

### DETAILED DESCRIPTION OF THE INVENTION

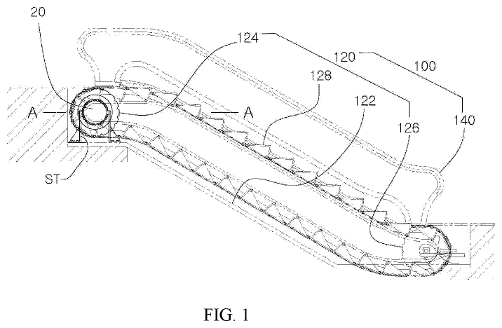

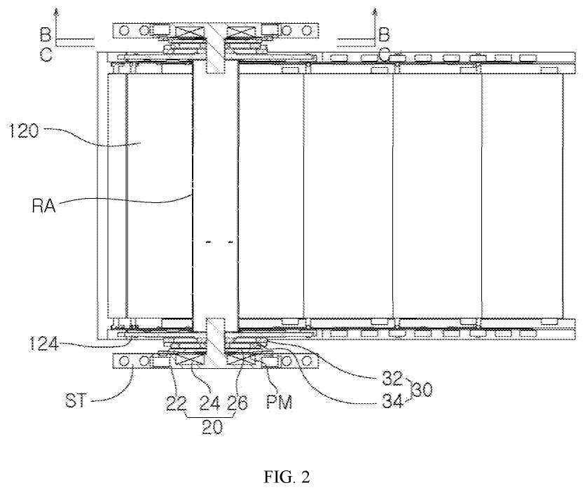

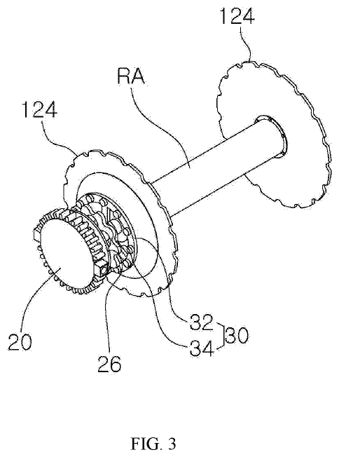

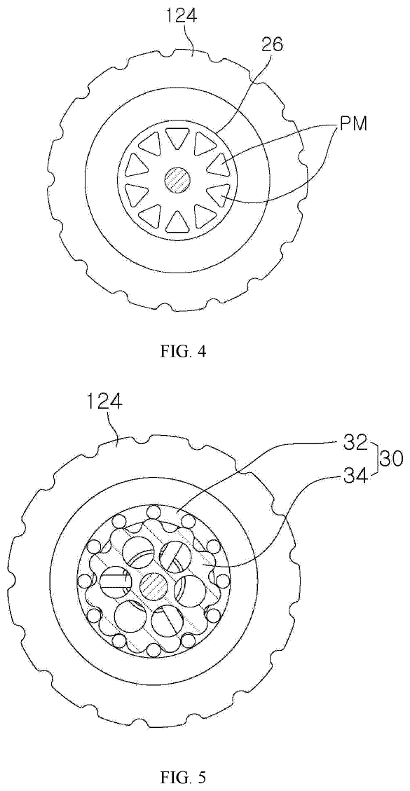

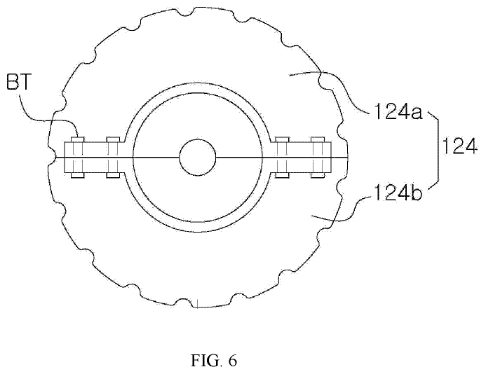

Hereinafter, an embodiment of the present invention will be described. FIGS. 1 to 5 illustrate the escalator according to the present invention in detail.

The present invention aims to provide a direct drive type escalator to solve the problems of operation interruption and safety accidents caused by a fracture of a power transmission system in an indirect drive type escalator, which is a mobility convenience facility provided in a step-like shape to move upward and downward between floors using power.

The escalator is broadly divided into a transport unit 100 for carrying passengers upward and downward, and a power generating unit 200 for driving the transport unit 100. At this time, the power generating unit 200 is installed as a pair on the left and right at any one side of the transport unit 100.

First, the transport unit 100 is configured with a carrier 120 driven by driving force transmitted from power generating units 200 provided on the left and right, and a handrail 140 provided alongside and interlocking with the carrier 120.

The carrier 120 is configured with a pair of left and right driving sprockets 124 and driven sprockets 126 installed at upper and lower portions of a truss 122, which is inclined with one side high and the other side low, and caterpillar-type steps 128 provided in a link chain manner across the driving and driven sprockets 124 and 126.

Here, each of the pair of left and right driving and driven sprockets 124 and 126 is integrally installed at both left and right ends of a rotating shaft RA with the rotating shaft RA positioned at the center.

In addition, the pair of left and right power generating units 20 are installed outward on the same axis as the driving sprockets 124, which are any one of the carrier 120, such that the pair of left and right power generating units 20 are simultaneously driven by a signal transmitted from an operation control unit, thereby driving the carrier 120 via a direct drive method.

The power generating unit 20 is an axial flux motor and is configured with a stator 24 having a circular shape that forms magnetic flux in a direction parallel to the rotating shaft RA of the driving sprocket 124 within a housing 22 fixedly installed by supports ST provided as a pair on the left and right on the truss 122, and a rotor 26 having a disk shape that is installed to face the stator 24 and has permanent magnets PM arranged radially.

Meanwhile, between the driving sprockets 124 of the carrier 120 and the power generating units 20, a cycloid transmission 30 having a disk shape is provided, which is installed coaxially to transmit driving force from the power generating units 20 to the driving sprockets 124 such that the driving sprockets rotates at reduced speed, thereby allowing the caterpillar-type steps 128 to travel at a constant low speed.

The cycloid transmission 30 is configured with a ring gear 32 being provided integrally with the driving sprocket 124, and a disk 34 being internally geared with the ring gear 32 and rotates eccentrically.

The power generating unit 20 and the cycloid transmission 30, each having a disk shape, are arranged in parallel in the longitudinal direction of the rotating shaft RA of the carrier 120 to enhance design flexibility in a limited space, and a transmission path through direct power transmission is shortened to reduce efficiency loss, simplify the structure, and reduce driving noise and vibration of the equipment.

In the escalator of the present invention configured as described above, when the power generating unit 20, which is an axial flux motor installed as a pair on the left and right coaxially with the driving sprocket 124 provided at the upper portion of the inclined carrier 120 of the transport unit 100, is driven by an operation signal transmitted from the operation control unit, a driving force is transmitted to the driving sprocket 124 through the cycloid transmission 30 provided coaxially therewith; accordingly, the caterpillar-type steps 128 travel at a constant low speed while maintaining a horizontal state at the top and bottom for boarding and alighting of passengers and converting into stairs in an inclined section, thereby safely carrying passengers to upper and lower floors.

FIG. 6 shows another embodiment of the driving and driven sprockets 124 and 126 in the present invention.

In this embodiment, the driving sprocket 124, which is one of the driving and driven sprockets 124 and 126, will be described by taking the case thereof as an example.

The driving sprocket 124 is configured with split parts 124a and 124b that are bisected along a diameter line passing through a center of rotation thereof to be freely separated or combined by being abutted and coupled with bolts BT; accordingly, when the driving sprocket 124 is replaced due to wear or damage, the driving sprocket 124 can be easily separated and replaced without disassembling a bearing house.

The escalator of the present invention ensures stable operation of the transport unit, facilitates management and maintenance, and can prevent safety accidents such as reverse running caused by a fracture in a power transmission system of a conventional indirect chain method.

In addition, the structure is simple, and the operation of the transport unit is stabilized with durability and high torque, while management and maintenance are facilitated.

Although embodiments according to the present invention have been described above, these are merely exemplary. Those with ordinary skill in the art will understand that various modifications and embodiments are possible. Therefore, the scope of protection of the present invention should be defined not only by the following claims but also by their equivalents. All the disclosed embodiments can be practiced without undue experimentation.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept.

Moreover, the individual components need not be formed in the disclosed shapes, or assembled in the disclosed configuration, but could be provided in virtually any shape, and assembled in virtually any configuration. Furthermore, all the disclosed features of each disclosed embodiment can be combined with, or substituted for, the disclosed features of every other disclosed embodiment except where such features are mutually exclusive.

It is intended that the appended claims cover all such additions, modifications and rearrangements. Expedient embodiments of the present invention are differentiated by the appended claims.

I claim:

1. An escalator having a power generating unit operated by a signal from an operation control unit, the escalator being configured with a transport unit including a carrier for carrying passengers upward and downward via caterpillar-type steps and handrails provided alongside both left and right sides of the carrier for passenger safety,
wherein driving and driven sprockets are installed as a pair on the left and right at upper and lower portions of an inclined truss using rotating shafts, and the caterpillar-type steps are installed across the driving and driven sprockets to travel by driving force transmitted from an output shaft of the power generating unit,
the escalator comprising:
the power generating unit, which is an axial flux motor installed on and coaxially with each of the pair of left and right driving sprockets; and
a cycloid transmission installed coaxially between the driving sprockets and the axial flux motor to transmit driving force from the axial flux motor to the driving sprockets such that the driving sprockets rotates at reduced speed, thereby allowing the caterpillar-type steps to travel at a constant low speed.

2. The escalator according to claim 1, wherein the power generating unit and the cycloid transmission are interconnected and arranged in parallel in a direction intersecting an axis of the driving sprocket, thereby allowing the carrier to be operated via a direct drive method.

3. The escalator according to claim 1, wherein the power generating unit is configured with a housing fixedly installed on the truss via a pair of left and right supports, a stator forming a magnetic flux in a direction parallel to an axis within the housing, and a rotor installed to face the stator and provided with permanent magnets arranged radially.

4. The escalator according to claim 1, wherein the cycloid transmission is configured with a ring gear provided integrally with the driving sprocket, and a disk that is inscribed in the ring gear and rotates eccentrically.

5. The escalator according to claim 1, wherein the driving and driven sprockets are configured to be separated or coupled by split parts formed by being bisected along a diameter line passing through a center of rotation thereof.
